(19) United States
(12) Patent Application Publication
(10) Pub. No.: US 2025/0307706 A1
(43) Pub. Date: Oct. 2, 2025

(54) SYSTEM AND METHOD FOR UPDATING ONE OR MORE OPTIMIZATION POLICIES IN DISTRIBUTED CLOUD ENVIRONMENTS

(71) Applicants: GHOUSE BASHA BATLAPADU, Tracy, CA (US); SOHA JASMINE BATLAPADU, Tracy, CA (US)

(72) Inventors: GHOUSE BASHA BATLAPADU, Tracy, CA (US); SOHA JASMINE BATLAPADU, Tracy, CA (US)

(21) Appl. No.: 19/053,438

(22) Filed: Feb. 14, 2025

(51) Int. Cl. G06N 20/00

(52) U.S. Cl. CPC G06N 20/00

(57) ABSTRACT

A system and method for updating the one or more optimization policies in distributed cloud environments. The method includes receiving, at an adaptive optimization engine, real-time performance metrics from one or more distributed cloud nodes. Further, the method includes analyzing the real-time performance metrics using one or more Machine Learning (ML) models. Furthermore, the method includes generating one or more optimization policies based on the analyzed the real-time performance metrics. The method includes dynamically assigning one or more computational tasks to the one or more distributed cloud nodes. Further, the method includes continuously retraining, by the adaptive optimization engine, the one or more ML models using performance feedback from the one or more distributed cloud nodes. The method includes updating the one or more optimization policies in the distributed cloud environments based the retrained one or more ML models.

### COPYRIGHT AND TRADEMARK NOTICE

This application includes material which is subject or may be subject to copyright and/or trademark protection. The copyright and trademark owner(s) have no objection to the facsimile reproduction by any of the patent disclosure, as it appears in the Patent and Trademark Office files or records, but otherwise reserves all copyright and trademark rights whatsoever.

### TECHNICAL FIELD

The present invention relates generally to field of machine learning and distributed computing systems. More particularly, to systems and methods for updating one or more optimization policies in distributed cloud environments.

### BACKGROUND OF THE INVENTION

In the modern era of big data, the ability to process and analyze large-scale datasets has become increasingly critical. Conventional approaches to data classification and clustering, such as k-means clustering, support vector machines (SVM), and decision trees, have shown limitations when dealing with highly complex and large datasets. Traditional techniques often fail to scale effectively or adapt to the diverse structures inherent in such data.

Deep learning has emerged as a transformative technology in various domains, providing solutions for tasks such as image recognition, natural language processing, and predictive analytics. Neural networks, particularly deep neural networks, possess the capacity to learn intricate patterns and representations from raw data. Despite promise, there remains a need for optimized systems and methods that leverage deep learning to enhance data classification and clustering across various industries.

Traditional deep learning models struggle with imbalanced workload distribution, leading to overloaded or underutilized cloud nodes. Distributed deep learning training often faces high latency and redundant computations, slowing down convergence. High communication overhead occurs due to frequent gradient exchanges between distributed nodes.

Model parameters and gradient updates are vulnerable to tampering, eavesdropping, and adversarial attacks during transmission. Existing deep learning optimization techniques rely on static policies, which fail to adapt to real-time system performance variations. If a distributed node fails, task execution halts, leading to delayed processing and system failures. Traditional systems lack an intelligent failure detection and recovery mechanism.

Existing solutions often lack strength in handling heterogeneous data, dynamic environments, and real-time processing requirements. Furthermore, integration of clustering techniques with deep learning frameworks poses challenges related to computational efficiency, scalability, and interpretability.

Therefore, there is need to develop a system and method to overcome aforementioned problems.

### SUMMARY OF THE INVENTION

This summary is provided to introduce a selection of concepts, in a simple manner, which is further described in the detailed description of the disclosure. This summary is neither intended to identify key or essential inventive concepts of the subject matter nor to determine the scope of the disclosure.

In accordance with an embodiment of the present disclosure, a method for updating the one or more optimization policies in distributed cloud environments is disclosed. The method includes receiving, at an adaptive optimization engine, real-time performance metrics from one or more distributed cloud nodes. Further, the method includes analyzing, by the adaptive optimization engine, the real-time performance metrics using one or more Machine Learning (ML) models. Furthermore, the method includes generating, by the adaptive optimization engine, one or more optimization policies based on the analyzed the real-time performance metrics. The one or more optimization policies comprises one or more resource allocation parameters, one or more model partitioning strategies, and one or more communication protocol adjustments. In addition, the method includes dynamically assigning, by the adaptive optimization engine, one or more computational tasks to the one or more distributed cloud nodes based on the generated one or more resource allocation parameters. Further, the method includes upon assigning the one or more computational tasks, continuously retraining, by the adaptive optimization engine, the one or more ML models using performance feedback from the one or more distributed cloud nodes. Furthermore, the method includes updating, by the adaptive optimization engine, the one or more optimization policies in the distributed cloud environments based the retrained one or more ML models.

In accordance with another embodiment of the present disclosure, a system for updating the one or more optimization policies in distributed cloud environments is disclosed. The system includes at least one memory and at least one processor operatively connected to the at least one memory. The at least one processor is configured to receive, using an adaptive optimization engine, real-time performance metrics from one or more distributed cloud nodes. Further, the at least one processor is configured to analyze, using the adaptive optimization engine, the real-time performance metrics using one or more Machine Learning (ML) models. Furthermore, at least one processor is configured to generate, by the adaptive optimization engine, one or more optimization policies based on the analyzed the real-time performance metrics. The one or more optimization policies comprises one or more resource allocation parameters, one or more model partitioning strategies, and one or more communication protocol adjustments. The at least one processor is configured to dynamically assign, using the adaptive optimization engine, one or more computational tasks to the one or more distributed cloud nodes based on the generated one or more resource allocation parameters. Upon assigning the one or more computational tasks, the at least one processor is configured to continuously retrain the one or more ML models using performance feedback from the one or more distributed cloud nodes. Further, the at least one processor is configured to update the one or more optimization policies in the distributed cloud environments based the retrained one or more ML models.

In accordance with another embodiment of the present disclosure, a non-transitory computer-readable medium storing instructions that, when executed, cause a processor to receive, at an adaptive optimization engine, real-time performance metrics from one or more distributed cloud nodes. Further, the processor to analyze, using the adaptive optimization engine, the real-time performance metrics using one or more Machine Learning (ML) models. Furthermore, the processor to generate, using the adaptive optimization engine, one or more optimization policies based on the analyzed the real-time performance metrics. The one or more optimization policies comprises one or more resource allocation parameters, one or more model partitioning strategies, and one or more communication protocol adjustments. In addition, the processor to dynamically, using the adaptive optimization engine, assign one or more computational tasks to the one or more distributed cloud nodes based on the generated one or more resource allocation parameters. Upon assigning the one or more computational tasks, continuously retrain, using the adaptive optimization engine, the one or more ML models using performance feedback from the one or more distributed cloud nodes. The processor to update, using the adaptive optimization engine, the one or more optimization policies in the distributed cloud environments based the retrained one or more ML models.

One or more advantages of the prior art are overcome, and additional advantages are provided through the invention. Additional features are realized through the technique of the invention. Other embodiments and aspects of the disclosure are described in detail herein and are considered a part of the invention.

### BRIEF DESCRIPTION OF THE FIGURES

The accompanying figures where like reference numerals refer to identical or functionally similar elements throughout the separate views and which together with the detailed description below are incorporated in and form part of the specification, serve to further illustrate various embodiments and to explain various principles and advantages all in accordance with the invention.

FIG. 1 is a block diagram depicting an exemplary environment of distributed cloud nodes associated with a system in distributed cloud environments, in accordance with an embodiment of the present disclosure;

FIG. 2 is a block diagram depicting a system for updating the one or more optimization policies in the distributed cloud environments, in accordance with an embodiment of the present disclosure; and

FIG. 3 is a process flow diagram depicting an exemplary method for updating the one or more optimization policies in the distributed cloud environments, in accordance with an embodiment of the present disclosure.

Skilled artisans will appreciate the elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE INVENTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed. It shall be understood that different aspects of the invention can be appreciated individually, collectively, or in combination with each other.

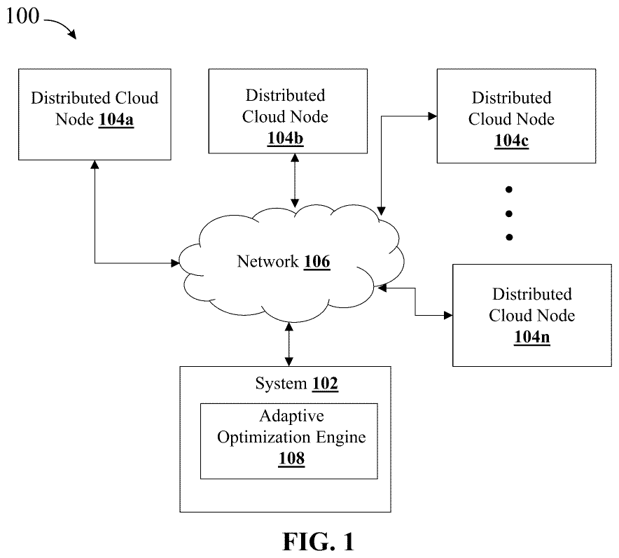

An environment and various implementations for ensures road safety by preventing drunk driving and enabling rapid emergency response. The environment and processes may be described with reference to FIG. 1 showing an architectural level schematic of a system in accordance with an implementation. Because FIG. 1 is an architectural diagram, certain details are intentionally omitted to improve the clarity of the description. The discussion of FIG. 1 will be organized as follows. First, the elements of the figure will be described, followed by their interconnections. Then, the use of the elements in the environment will be described in greater detail. The environment provides power of deep learning neural networks for data classification and clustering.

Referring now to the drawings, and more particularly to FIG. 1 through FIG. 3, where similar reference characters denote corresponding features consistently throughout the figures, there are shown preferred embodiments and these embodiments are described in the context of the following exemplary system and/or method.

FIG. 1 is a block diagram 100 depicting an exemplary environment FIG. 1 of distributed cloud nodes associated with a system in distributed cloud environments, in accordance with an embodiment of the present disclosure. The distributed cloud environments may refer to a computing architecture where cloud resources distributed across multiple locations rather than being centralized in a single data center. The cloud resources may include, but are not limited to, servers, storage devices, processing power devices, and the like. The distributed cloud environments may enable efficient, scalable, and resilient deep learning model training and deployment by leveraging geographically dispersed infrastructure.

According to FIG. 1, the exemplary environment 100 includes a system 102, one or more distributed cloud nodes 104a, 104b, 104c . . . 104n, and a network 106. The network 106 may include an internet. The network 106 may be rapidly emerging as a preferred system for distributing and exchanging data. The network 106 may include a cellular network, a public land mobile network (PLMN), a second generation (2G) network, a third generation (3G) network, a fourth generation (4G) network (e.g., a long-term evolution (LTE) network), a fifth generation (5G) network, and/or another network. Additionally, or alternatively, the network 106 may include a wide area network (WAN), a metropolitan network (MAN), a telephone network (e.g., the Public Switched Telephone Network (PSTN)), an ad hoc network, an intranet, an Internet, a fiber optic-based network, and/or a combination of these or other types of networks.

The system 102 may include an adaptive optimization engine 108. In an embodiment, the system 102 may be connected to the each of the one or more distributed cloud nodes 104a, 104b, 104c . . . 104n through the network 106. In another embodiment, each of the one or more distributed cloud nodes 104a, 104b, 104c . . . 104n may include the system 102.

The one or more distributed cloud nodes 104a, 104b, 104c . . . 104n may include, but are not limited to, one or more Graphical Processing Units (GPUs), one or more Tensor Processing Units (TPUs), and one or more Central Processing Units (CPU), and the like. The one or more distributed cloud nodes 104a, 104b, 104c . . . 104n may be geographically distributed across a plurality of data centers. The one or more distributed cloud nodes 104a, 104b, 104c . . . 104n may be represented as interconnected servers or virtual machines.

The adaptive optimization engine 108 may be configured to prioritize data routing between the one or more distributed cloud nodes 104a, 104b, 104c . . . 104n based on physical proximity. The adaptive optimization engine 108 may be a software-based system that dynamically enhances the performance of one or more Machine Learning (ML) models in the distributed cloud environments. The one or more ML models may include one or more reinforcement learning models, one or more supervised learning models, one or more unsupervised learning models, and the like. The one or more reinforcement learning models may enable the system 102 to dynamically adjust resource allocation and model partitioning based on real-time performance feedback. For example, Deep Q-Networks (DQN), Policy Gradient Methods. The one or more supervised learning models may be used for predicting resource consumption patterns and task completion times based on labeled performance data. For example, decision trees, random forest, Gradient Boosting Machines (GBM). The one or more unsupervised learning models may be used for detecting anomalies in system performance, such as unexpected node failures or security threats. For example, K-Means clustering, isolation forest. The adaptive optimization engine 108 may be a hardware element configured to intelligently allocate resources, adjust model configurations, and optimize execution strategies in real time based on system conditions and workload demands.

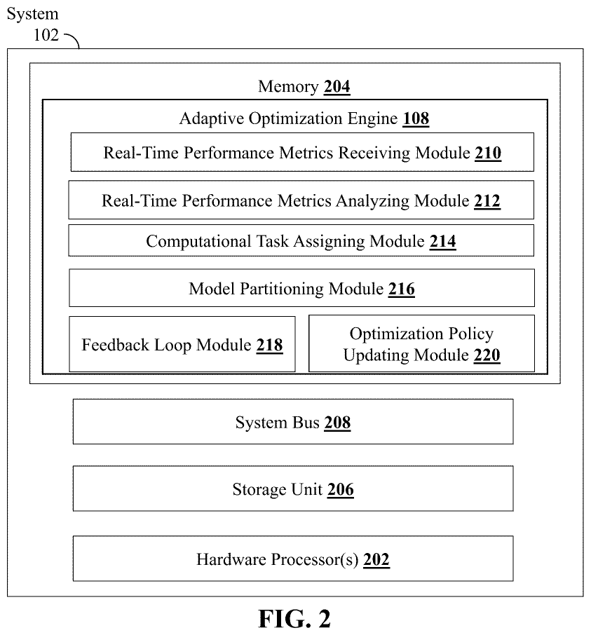

FIG. 2 is a block diagram 200 depicting the system 102 for updating the one or more optimization policies in the distributed cloud environments, in accordance with an embodiment of the present disclosure. The one or more optimization policies may include one or more resource allocation parameters, one or more model partitioning strategies, and one or more communication protocol adjustments. The one or more resource allocation parameters may improve system efficiency, load balancing, and training speed. The one or more resource allocation parameters may define how computational resources (such as CPU, GPU, memory, and network bandwidth) are distributed among the one or more distributed cloud nodes 104a, 104b, 104c . . . 104n for optimal deep learning performance. Examples of resource allocation parameters may include,
a. CPU/GPU Allocation: Determines the number of processing units assigned to each task.
b. Memory allocation: adjust Random Access Memory (RAM) usage to optimize deep learning training without exceeding node limits.
c. Bandwidth Allocation: Manages network resources to prevent bottlenecks during inter-node communication.
d. Task prioritization: ensures critical tasks receive higher resource priority based on workload demands.

The one or more model partitioning strategies may define how a deep learning model is divided and distributed across the one or more distributed cloud nodes 104a, 104b, 104c . . . 104n for parallel processing. The one or more model partitioning strategies may include layer-wise partitioning, data parallelism, model parallelism, and hybrid partitioning. The layer-wise partitioning may include different layers of the model. The different layers may be assigned to the one or more distributed cloud nodes 104a, 104b, 104c . . . 104n. In the data parallelism, each distributed cloud node 104a or 104b or 104c . . . 104n processes a different batch of data while keeping a copy of the full model. In the model parallelism, a model is split across the one or more distributed cloud nodes 104a, 104b, 104c . . . 104n, with each handling a part of the computation. In the hybrid partitioning, combines data and model parallelism for optimal performance. The one or more model partitioning strategies may reduce training time, minimizes computation load on the one or more distributed cloud nodes 104a, 104b, 104c . . . 104n, and enhances scalability.

The one or more communication protocol adjustments may optimize how the one or more distributed cloud nodes 104a, 104b, 104c . . . 104n exchange data, gradients, and parameters during distributed model training. Examples of the one or more communication protocol adjustments may include gradient compression. The gradient compression reduces the size of transmitted gradients to speed up synchronization. The one or more communication protocol adjustments may include asynchronous training. The asynchronous training may allow the one or more distributed cloud nodes 104a, 104b, 104c . . . 104n to update the model at different times instead of all at once. The one or more communication protocol adjustments may include bandwidth optimization. The bandwidth optimization may dynamically adjust data transmission rates based on network conditions. Further, the one or more communication protocol adjustments may include secure transmission. The secure transmission may ensure secure gradient updates to prevent adversarial attacks. The one or more communication protocol adjustments may reduce latency, prevent communication overhead, and enhance security in the one or more distributed cloud nodes 104a, 104b, 104c . . . 104n.

According to FIG. 2, the system 102 may include one or more hardware processors 202, a memory 204 and a storage unit 206. The one or more hardware processors 202, the memory 204 and the storage unit 206 may be communicatively coupled through a system bus 208 or any similar mechanism. The memory 204 may include the adaptive optimization engine 108 in the form of programmable instructions executable by the one or more hardware processors 202. Further, the adaptive optimization engine 108 may include a real-time performance metrics receiving module 210, a real-time performance metrics analyzing module 212, a computational task assigning module 214, a model partitioning module 216, a feedback loop module 218, and an optimization policy updating module 220.

The real-time performance metrics receiving module 210 may be configured to monitor real-time performance metrics of the one or more one or more distributed cloud nodes 104a, 104b, 104c . . . 104n. The real-time performance metrics may include, but is not limited to, node resource utilization and task completion time. For example, the node resource utilization measures how efficiently individual distributed cloud nodes 104a, 104b, 104c . . . 104n are being used within the distributed cloud environments. The node resource utilization may include percentage of processing power being used at any given time, the amount of RAM consumed by active processes. The node resource utilization may include the amount of data transmitted between nodes per second. Further, the node resource utilization may include energy usage of each node, which may impact cost and efficiency. The task completion time may refer to duration required to execute a computational task.

The real-time performance metrics analyzing module 212 may be configured to analyze the real-time performance metrics using the one or more ML models. In an example scenario, the distributed cloud nodes 104a reports a GPU utilization at 95% (critical threshold). Network latency between the distributed cloud node 104a and the distributed cloud node 104b spikes from 5 ms to 50 ms. The real-time performance metrics analyzing module 212 may flag the latency spike as a potential bottleneck. The real-time performance metrics analyzing module 212 may be configured to predict that the GPU overload will persist for the next 5 minutes. The distributed cloud node 104a recommends migrating compute-intensive subgraphs to an underutilized distributed cloud node 104c.

The computational task assigning module 214 may be configured to dynamically assign one or more computational tasks to the one or more distributed cloud nodes 104a, 104b, 104c . . . 104n based the one or more resource allocation parameters. The one or more computational tasks may include, but are not limited to, one or more model training tasks, one or more inference tasks, one or more data preprocessing and augmentation tasks, one or more distributed computing and parallel processing tasks, one or more optimization and adaptive resource allocation tasks, one or more security and encryption tasks, and the like.

The one or more model training tasks may include perform forward and backward propagation to update model parameters, compute the gradients using optimization techniques, and execute multiple iterations to improve model accuracy. The one or more inference tasks may include apply trained models to new data for predictions or classifications, process inputs through neural network layers to generate outputs, and optimize inference speed by reducing latency and computational overhead.

The one or more data preprocessing and augmentation tasks may include clean, normalize, and transform raw data before feeding the tasks into the one or more ML models. Further, the one or more data preprocessing and augmentation tasks may include augmenting training data using techniques like cropping, rotation, and noise addition. Furthermore, the one or more data preprocessing and augmentation tasks may include perform feature extraction and dimensionality reduction.

The one or more distributed computing and parallel processing tasks may include split large computations across the one or more distributed cloud nodes 104a, 104b, 104c . . . 104n to improve efficiency. Further, implement parallel training strategies such as data parallelism and model parallelism and synchronize model updates across the one or more distributed cloud nodes 104a, 104b, 104c . . . 104n.

The optimization and adaptive resource allocation tasks may include allocating the one or more distributed cloud nodes 104a, 104b, 104c . . . 104n dynamically based on workload and demand. The optimization and adaptive resource allocation tasks may include adjusting model partitioning strategies to minimize communication overhead and apply reinforcement learning-based optimization.

The one or more security and encryption tasks may include encrypting data and the gradients for secure transmission across the one or more distributed cloud nodes 104a, 104b, 104c . . . 104n. The one or more security and encryption tasks may include implement privacy-preserving techniques like homomorphic encryption and differential privacy. Further, the one or more security and encryption tasks may include verify data integrity using cryptographic hashing and anomaly detection.

The model partitioning module 216 may be configured to split a deep learning model into a plurality of subgraphs based on the one or more model partitioning strategies. The plurality of subgraphs may be optimized for parallel execution across the one or more distributed cloud nodes. The plurality of subgraphs may be created by grouping interdependent layers into cohesive units. The interdependent layers may include, but are not limited to, convolutional blocks, attention heads or operations (e.g., matrix multiplications, activation functions), and the like.

The model partitioning module 216 may be configured to balance computational load across the the one or more distributed cloud nodes subgraphs. Further, the model partitioning module 216 may be configured to minimize inter-node communication overhead during forward or backward propagation, and align operations of the plurality of subgraphs with hardware acceleration capabilities of the one or more distributed cloud nodes 104a, 104b, 104c . . . 104n.

The adaptive optimization engine 108 may be configured to deploy the plurality of subgraphs to the one or more distributed cloud nodes 104a, 104b, 104c . . . 104n. The plurality of subgraphs may be deployed based on hardware capabilities and network topology of the one or more distributed cloud nodes 104a, 104b, 104c . . . 104n.

The feedback loop module 218 may be configured to continuously retrain the one or more ML models using performance feedback from the one or more distributed cloud nodes 104a, 104b, 104c . . . 104n. The performance feedback may refer to the continuous stream of real-time operational data received from the one or more distributed cloud nodes 104a, 104b, 104c . . . 104n that reflects the efficiency, utilization, and effectiveness of the deep learning model. The performance feedback may be used to dynamically adjust and improve the performance of the one or more ML models.

The optimization policy updating module 220 may be configured to update the one or more optimization policies in the distributed cloud environments based the retrained one or more ML models. The one or more optimization policies may be updated to optimize the CPU, the GPU, and memory distribution based on real-time workload patterns. Further, the one or more optimization policies may be updated based on improved predictions, anomaly detections, and performance trends from the retrained ML models.

Further, the one or more optimization policies may be updated for training, inference, and data processing to reduce latency and improve throughput. Furthermore, the one or more optimization policies may be updated for auto-scaling cloud resources and optimizing workload distribution across the one or more distributed cloud nodes 104a, 104b, 104c . . . 104n.

Further, the adaptive optimization engine 108 may be configured to detect one or more failures of the one or more distributed cloud nodes 104a, 104b, 104c . . . 104n. The one or more failures may refer to disruptions, malfunctions, or inefficiencies in the one or more distributed cloud nodes 104a, 104b, 104c . . . 104n that impact the performance, reliability, and availability of deep learning computations. The one or more failures may be categorized into different types. The different types of failures may include, but are not limited to, hardware failures, software failures, network failures, security and integrity failures, and computational and performance failures.

The hardware failures may include the CPU or the GPU crashes or overheating, memory leaks or storage failures, and network interface card (NIC) malfunctions. The software failures may include operating system crashes or kernel panics, application or model execution failures, and corrupt or incompatible software dependencies. Further, the network failures may include, but are not limited to, high latency, packet loss, or disconnections between the one or more distributed cloud nodes 104a, 104b, 104c . . . 104n.

The security and integrity failures may include unauthorized access or cyberattacks affecting node performance, data corruption due to adversarial attacks or transmission errors, and compromised encryption affecting secure gradient exchanges. The computational and performance failures may include excessive resource utilization leading to node slowdowns. Further, the computational and performance failures may include unbalanced workload distribution causing inefficiencies. Furthermore, the computational and performance failures may include model convergence failures due to poor parameter tuning.

Upon detecting the one or more failures, the adaptive optimization engine 108 may be configured to activate reallocation of the one or more computational tasks to the one or more distributed cloud nodes 104a, 104b, 104c . . . 104n. The reallocation of the one or more computational tasks may be activated using the retrained one or more ML models. Furthermore, the adaptive optimization engine 108 may be configured to encrypt one or more gradients during inter-node communication using one or more encryption techniques. The one or more gradients are the partial derivatives of a loss function with respect to parameters (weights and biases) of a neural network. During training of the one or more ML models, the one or more gradients may be computed via backpropagation and used to update model parameters to minimize loss. In distributed environments, the one or more gradients may be exchanged between the one or more distributed cloud nodes 104a, 104b, 104c . . . 104n to synchronize model updates. For example, in a distributed training setup for an image classifier, the one or more gradients from mini-batches processed on the one or more distributed cloud nodes 104a, 104b, 104c . . . 104n. The one or more gradients are aggregated to update a global model.

To secure the one or more gradients during inter-node communication, the adaptive optimization engine 108 employs the one or more encryption techniques. The one or more encryption techniques may include, but are not limited to, homomorphic encryption, Secure Multi-Party Computation (SMPC), Differential Privacy (DP), quantum-resistant encryption, and hybrid approaches.

In an example scenario, the adaptive optimization engine 108 may include a privacy-preserving medical imaging model. Further, the adaptive optimization engine 108 may be configured to provide homomorphic encryption mode. In an example, hospitals encrypt gradients from patient data using homomorphic encryption. The adaptive optimization engine 108 may be configured to aggregate encrypted gradients and updates the global model without accessing raw data.

In another scenario, the adaptive optimization engine 108 may include cross-organization collaboration. Further, the adaptive optimization engine 108 provides Secure Multi-Party Computation (SMPC) encryption mode. In an example, two companies collaboratively train a fraud detection model. Gradients are split into secret shares, aggregated via the SMPC, and no party sees the another's data.

In another scenario, the adaptive optimization engine 108 may include edge device training. Further, the adaptive optimization engine 108 provides Advanced Encryption Standard (AES)-Galois/Counter Mode (GCM) encryption mode. Edge devices encrypt gradients with the AES-GCM and add DP noise before sending to the one or more distributed cloud nodes 104a, 104b, 104c . . . 104n.

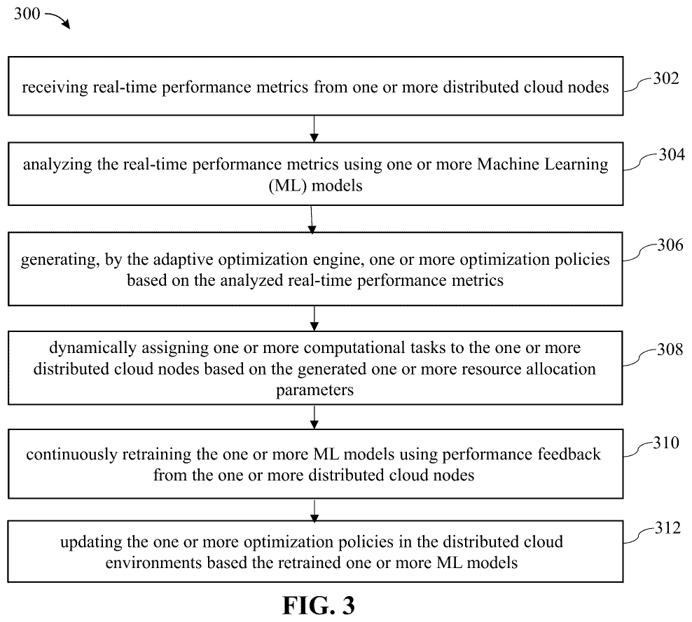

FIG. 3 is a process flow diagram 300 illustrating an exemplary method for updating the one or more optimization policies in distributed cloud environments, in accordance with an embodiment of the present disclosure.

At step 302, the method 300 may include receiving, at the adaptive optimization engine 108, real-time performance metrics from the one or more distributed cloud nodes 104a, 104b, 104c . . . 104n.

At step 304, the method 300 may include analyzing, by the adaptive optimization engine 108, the real-time performance metrics using the one or more ML models.

At step 306, the method 300 may include generating, by the adaptive optimization engine 108, the one or more optimization policies based on the analyzed real-time performance metrics. The one or more optimization policies may include the one or more resource allocation parameters, the one or more model partitioning strategies, and the one or more communication protocol adjustments.

At step 308, the method 300 may include dynamically assigning, by the adaptive optimization engine 108, the one or more computational tasks to the one or more distributed cloud nodes 104a, 104b, 104c . . . 104n based on the generated one or more resource allocation parameters.

Upon assigning the one or more computational tasks, at step 310, the method 300 may include continuously retraining, by the adaptive optimization engine 108, the one or more ML models using performance feedback from the one or more distributed cloud nodes 104a, 104b, 104c . . . 104n.

At step 312, the method 300 may include updating, by the adaptive optimization engine 108, the one or more optimization policies in the distributed cloud environments based the retrained one or more ML models.

The method 300 may include splitting, by the adaptive optimization engine 108, the deep learning model into the plurality of subgraphs based on the one or more model partitioning strategies. The plurality of subgraphs may be optimized for parallel execution across the one or more distributed cloud nodes 104a, 104b, 104c . . . 104n. In an embodiment, the plurality of subgraphs may be optimized using the balancing computational load across the one or more distributed cloud nodes 104a, 104b, 104c . . . 104n. In another embodiment, the plurality of subgraphs may be optimized using minimizing inter-node communication overhead during forward or backward propagation, and aligning operations of the plurality of subgraphs with hardware acceleration capabilities of the one or more distributed cloud nodes 104a, 104b, 104c . . . 104n.

The method 300 may include deploying, by the adaptive optimization engine 108, the plurality of subgraphs to the one or more distributed cloud nodes 104a, 104b, 104c . . . 104n based on the hardware capabilities and the network topology of the one or more distributed cloud nodes 104a, 104b, 104c . . . 104n.

The method 300 may include detecting, by the adaptive optimization engine 108, the one or more failures of the one or more distributed cloud nodes 104a, 104b, 104c . . . 104n. Upon detecting the one or more failures, the method 300 may include activating reallocation of the one or more computational tasks to the one or more distributed cloud nodes 104a, 104b, 104c . . . 104n using the retrained one or more ML models. The method 300 may include encrypting, by the adaptive optimization engine 108, the one or more gradients during inter-node communication using the one or more encryption techniques.

The methods may be implemented in any suitable hardware, software, firmware, or combination thereof.

Thus, various embodiments of the present invention provide the system for updating the one or more optimization policies in the distributed cloud environments. The adaptive optimization engine continuously refines resource allocation, model partitioning, and communication protocols using live telemetry (e.g., node load, network latency). For example, adjusts gradient compression ratios during network congestion to balance bandwidth usage and model accuracy.

The adaptive optimization engine automatically migrates subgraphs or reprovisions nodes in response to failures, latency spikes, or workload changes. The adaptive optimization engine matches subgraph operations (e.g., matrix multiplications, embeddings) to the distributed cloud nodes with specialized accelerators (GPUs, TPUs, CPUs). For example, assigns transformer attention layers to high-memory TPU nodes and data preprocessing to CPU nodes. Prioritizes nodes in low-carbon regions for compute-intensive tasks, reducing the system's carbon footprint.

The adaptive optimization engine minimizes inter-node latency by routing data through physically proximate nodes (e.g., within the same data center rack). Further, the adaptive optimization engine dynamically applies quantization based on network bandwidth. Example: Uses 8-bit quantization during peak network usage to reduce gradient size by 75%.

The adaptive optimization engine splits models into subgraphs with balanced computational loads using graph neural networks (GNNs) to predict inter-layer dependencies. Example: Isolates ResNet-50's convolutional blocks into subgraphs for parallel GPU execution. The adaptive optimization engine combines data parallelism (splitting batches) and model parallelism (splitting layers) to scale large models (e.g., GPT-4) across thousands of nodes.

Secures inter-node communication via homomorphic encryption (HE) or secure multi-party computation (SMPC), ensuring raw gradients are never exposed. Example: Hospitals collaboratively train a cancer detection model without sharing patient data.

The adaptive optimization engine dynamically reduces power usage by shutting down underutilized distributed cloud nodes. The adaptive optimization engine continuously monitors node health and reassigns tasks if a distributed cloud node fails. The adaptive optimization engine implements backup nodes to prevent training interruptions in case of failures. The adaptive optimization engine efficiently partitions large deep learning models, distributing computations across distributed cloud nodes for faster convergence. The adaptive optimization engine minimizes communication overhead using adaptive communication protocols (e.g., compression, quantization). The adaptive optimization engine dynamically assigns deep learning tasks across multiple distributed cloud nodes, preventing bottlenecks and idle resources.

Examples of the techniques and system described herein include, but are not limited to, the following enumerated embodiments:
A method for updating one or more optimization policies in distributed cloud environments, includes,
i. receiving, at an adaptive optimization engine, real-time performance metrics from one or more distributed cloud nodes,
ii. analyzing, by the adaptive optimization engine, the real-time performance metrics using one or more Machine Learning (ML) models,
iii. generating, by the adaptive optimization engine, one or more optimization policies based on the analyzed real-time performance metrics, wherein the one or more optimization policies comprises one or more resource allocation parameters, one or more model partitioning strategies, and one or more communication protocol adjustments,
iv. dynamically assigning, by the adaptive optimization engine, one or more computational tasks to the one or more distributed cloud nodes based on the generated one or more resource allocation parameters,
v. upon assigning the one or more computational tasks, continuously retraining, by the adaptive optimization engine, the one or more ML models using performance feedback from the one or more distributed cloud nodes, and
vi. updating, by the adaptive optimization engine, the one or more optimization policies in the distributed cloud environments based the retrained one or more ML models.

The method as described in paragraph [067], the real-time performance metrics comprises node resource utilization and task completion times.

The method as described in paragraphs [067]-[068], wherein the one or more ML models comprises one or more reinforcement learning models, one or more supervised learning models, one or more unsupervised learning models.

The method as described in paragraphs [067]-[069], the one or more distributed cloud nodes comprises at least one of one or more Graphical Processing Units (GPUs), one or more Tensor Processing Units (TPUs), and one or more Central Processing Units (CPU), and wherein the one or more distributed cloud nodes geographically distributed across a plurality of data centers, wherein the adaptive optimization engine prioritizes data routing between the one or more distributed cloud nodes based on physical proximity.

The method as described in paragraphs [067]-[070], wherein the adaptive optimization engine integrates historical performance data to enhance optimization accuracy.

The method as described in paragraphs [067]-[071], splitting, by the adaptive optimization engine, a deep learning model into a plurality of subgraphs based on the one or more model partitioning strategies, wherein the plurality of subgraphs is optimized for parallel execution across the one or more distributed cloud nodes by at least one of balancing computational load across the the one or more distributed cloud nodes subgraphs, minimizing inter-node communication overhead during forward or backward propagation, and aligning operations of the plurality of subgraphs with hardware acceleration capabilities of the one or more distributed cloud nodes.

The method as described in paragraphs [067]-[072], deploying, by the adaptive optimization engine, the plurality of subgraphs to the one or more distributed cloud nodes based on hardware capabilities and the network topology of the one or more distributed cloud nodes.

The method as described in paragraphs [067]-[073], detecting, by the adaptive optimization engine, one or more failures of the one or more distributed cloud nodes; and upon detecting the one or more failures, activating reallocation of the one or more computational tasks to the one or more distributed cloud nodes using the retrained one or more ML models.

The method as described in paragraphs [067]-[074], encrypting, by the adaptive optimization engine, one or more gradients during inter-node communication using one or more encryption techniques.

A system for updating the one or more optimization policies in distributed cloud environments, includes
i. at least one memory;
ii. at least one processor operatively connected to the at least one memory, wherein the at least one processor is configured to:
iii. receive, using an adaptive optimization engine, real-time performance metrics from one or more distributed cloud nodes;
iv. analyze, using the adaptive optimization engine, the real-time performance metrics using one or more Machine Learning (ML) models;
v. generate, by the adaptive optimization engine, one or more optimization policies based on the analyzed the real-time performance metrics, wherein the one or more optimization policies comprises one or more resource allocation parameters, one or more model partitioning strategies, and one or more communication protocol adjustments;
vi. dynamically assign, using the adaptive optimization engine, one or more computational tasks to the one or more distributed cloud nodes based on the generated one or more resource allocation parameters;
vii. upon assigning the one or more computational tasks, continuously retrain, using the adaptive optimization engine, the one or more ML models using performance feedback from the one or more distributed cloud nodes; and viii. update, using the adaptive optimization engine, the one or more optimization policies in the distributed cloud environments based the retrained one or more ML models.

The system as described in paragraph [076], wherein the real-time performance metrics comprises node resource utilization and task completion times.

The system as described in paragraphs [076]-[077], wherein the one or more ML models comprises one or more reinforcement learning models, one or more supervised learning models, and one or more unsupervised learning models.

The system as described in paragraphs [076]-[078], wherein the one or more distributed cloud nodes comprises at least one of one or more Graphical Processing Units (GPUs), one or more Tensor Processing Units (TPUs), and one or more Central Processing Units (CPU), and wherein the one or more distributed cloud nodes geographically distributed across a plurality of data centers, wherein the adaptive optimization engine prioritizes data routing between the one or more distributed cloud nodes based on physical proximity.

The system as described in paragraphs [076]-[079], wherein the adaptive optimization engine integrates historical performance data to enhance optimization accuracy.

The system as described in paragraphs [076]-[080], wherein the at least one processor is configured to split, using the adaptive optimization engine, a deep learning model into a plurality of subgraphs based on the one or more model partitioning strategies, wherein the plurality of subgraphs is optimized for parallel execution across the distributed cloud nodes by at least one of balancing computational load across the the one or more distributed cloud nodes subgraphs, minimizing inter-node communication overhead during forward or backward propagation, and aligning operations of the plurality of subgraphs with hardware acceleration capabilities of the one or more distributed cloud nodes.

The system as described in paragraphs [076]-[081], wherein the at least one processor is configured to: deploy, using the adaptive optimization engine, the plurality of subgraphs to the one or more distributed cloud nodes based on hardware capabilities and the network topology of the one or more distributed cloud nodes.

The system as described in paragraphs [076]-[082], wherein the at least one processor is configured to: detect, using the adaptive optimization engine, one or more failures of the one or more distributed cloud nodes; and upon detecting the one or more failures, activate reallocation of the one or more computational tasks to the one or more distributed cloud nodes using the retrained one or more ML models.

The system as described in paragraphs [076]-[083], wherein the at least one processor is configured to: encrypt, using the adaptive optimization engine, one or more gradients during inter-node communication using one or more encryption techniques.

A non-transitory computer-readable medium storing instructions that, when executed, cause a processor to:
i. receive, at an adaptive optimization engine, real-time performance metrics from one or more distributed cloud nodes;
ii. analyze, using the adaptive optimization engine, the real-time performance metrics using one or more Machine Learning (ML) models;
iii. generate, using the adaptive optimization engine, one or more optimization policies based on the analyzed the real-time performance metrics, wherein the one or more optimization policies comprises one or more resource allocation parameters, one or more model partitioning strategies, and one or more communication protocol adjustments;
iv. dynamically assign, using the adaptive optimization engine, one or more computational tasks to the one or more distributed cloud nodes based on the generated one or more resource allocation parameters;
v. upon assigning the one or more computational tasks, continuously retrain, using the adaptive optimization engine, the one or more ML models using performance feedback from the one or more distributed cloud nodes; and
vi. update, using the adaptive optimization engine, the one or more optimization policies in the distributed cloud environments based the retrained one or more ML models.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

The embodiments herein can comprise hardware and software elements. The embodiments that are implemented in software include but are not limited to, firmware, resident software, microcode, etc. The functions performed by various modules described herein may be implemented in other modules or combinations of other modules. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random-access memory (RAM), a read-only memory (ROM), a rigid magnetic disk and an optical disk. Current examples of optical disks include compact disk-read only memory (CD-ROM), compact disk-read/write (CD-R/W) and DVD.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

A representative hardware environment for practicing the embodiments may include a hardware configuration of an information handling/computer system in accordance with the embodiments herein. The system herein comprises at least one processor or central processing unit (CPU). The CPUs are interconnected via system bus 208 to various devices such as a random-access memory (RAM), read-only memory (ROM), and an input/output (I/O) adapter. The I/O adapter can connect to peripheral devices, such as disk units and tape drives, or other program storage devices that are readable by the system. The system can read the inventive instructions on the program storage devices and follow these instructions to execute the methodology of the embodiments herein.

The system further includes a user interface adapter that connects a keyboard, mouse, speaker, microphone, and/or other user interface devices such as a touch screen device (not shown) to the bus to gather user input. Additionally, a communication adapter connects the bus to a data processing network, and a display adapter connects the bus to a display device which may be embodied as an output device such as a monitor, printer, or transmitter, for example.

A description of an embodiment with several components in communication with each other does not imply that all such components are required. On the contrary, a variety of optional components are described to illustrate the wide variety of possible embodiments of the invention. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open-ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

What is claimed is:

1. A method for updating one or more optimization policies in distributed cloud environments, comprising:
receiving, at an adaptive optimization engine, real-time performance metrics from one or more distributed cloud nodes;
analyzing, by the adaptive optimization engine, the real-time performance metrics using one or more Machine Learning (ML) models;
generating, by the adaptive optimization engine, one or more optimization policies based on the analyzed the real-time performance metrics, wherein the one or more optimization policies comprises one or more resource allocation parameters, one or more model partitioning strategies, and one or more communication protocol adjustments;
dynamically assigning, by the adaptive optimization engine, one or more computational tasks to the one or more distributed cloud nodes based on the generated one or more resource allocation parameters;
upon assigning the one or more computational tasks, continuously retraining, by the adaptive optimization engine, the one or more ML models using performance feedback from the one or more distributed cloud nodes; and
updating, by the adaptive optimization engine, the one or more optimization policies in the distributed cloud environments based the retrained one or more ML models.

2. The method of claim 1, wherein the real-time performance metrics comprises node resource utilization and task completion times.

3. The method of claim 1, wherein the one or more ML models comprises one or more reinforcement learning models, one or more supervised learning models, and one or more unsupervised learning models.

4. The method of claim 1, wherein the one or more distributed cloud nodes comprises at least one of one or more Graphical Processing Units (GPUs), one or more Tensor Processing Units (TPUs), and one or more Central Processing Units (CPU).

5. The method of claim 1, wherein the adaptive optimization engine integrates historical performance data to enhance optimization accuracy.

6. The method of claim 1, further comprising:
splitting, by the adaptive optimization engine, a deep learning model into a plurality of subgraphs based on the one or more model partitioning strategies, wherein the plurality of subgraphs is optimized for parallel execution across the one or more distributed cloud nodes by at least one of balancing computational load across the the one or more distributed cloud nodes subgraphs, minimizing inter-node communication overhead during forward or backward propagation, and aligning operations of the plurality of subgraphs with hardware acceleration capabilities of the one or more distributed cloud nodes.

7. The method of claim 6, further comprising:
deploying, by the adaptive optimization engine, the plurality of subgraphs to the one or more distributed cloud nodes based on the hardware capabilities and network topology of the one or more distributed cloud nodes.

8. The method of claim 1, further comprising:
detecting, by the adaptive optimization engine, one or more failures of the one or more distributed cloud nodes; and
upon detecting the one or more failures, activating reallocation of the one or more computational tasks to the one or more distributed cloud nodes using the retrained one or more ML models.

9. The method of claim 1, further comprising:
encrypting, by the adaptive optimization engine, one or more gradients during inter-node communication using one or more encryption techniques.

10. A system for updating one or more optimization policies in distributed cloud environments, comprising:
at least one memory;
at least one processor operatively connected to the at least one memory, wherein the at least one processor is configured to:
receive, using an adaptive optimization engine, real-time performance metrics from one or more distributed cloud nodes;
analyze, using the adaptive optimization engine, the real-time performance metrics using one or more Machine Learning (ML) models;
generate, by the adaptive optimization engine, one or more optimization policies based on the analyzed the real-time performance metrics, wherein the one or more optimization policies comprises one or more resource allocation parameters, one or more model partitioning strategies, and one or more communication protocol adjustments;
dynamically assign, using the adaptive optimization engine, one or more computational tasks to the one or more distributed cloud nodes based on the generated one or more resource allocation parameters;
upon assigning the one or more computational tasks, continuously retrain, using the adaptive optimization engine, the one or more ML models using performance feedback from the one or more distributed cloud nodes; and
update, using the adaptive optimization engine, the one or more optimization policies in the distributed cloud environments based the retrained one or more ML models.

11. The system of claim 10, wherein the real-time performance metrics comprises node resource utilization and task completion times.

12. The system of claim 10, wherein the one or more ML models comprises one or more reinforcement learning models, one or more supervised learning models, and one or more unsupervised learning models.

13. The system of claim 10, wherein the one or more distributed cloud nodes comprises at least one of one or more Graphical Processing Units (GPUs), one or more Tensor Processing Units (TPUs), and one or more Central Processing Units (CPU), and wherein the one or more distributed cloud nodes geographically distributed across a plurality of data centers, wherein the adaptive optimization engine prioritizes data routing between the one or more distributed cloud nodes based on physical proximity.

14. The system of claim 10, wherein the adaptive optimization engine integrates historical performance data to enhance optimization accuracy.

15. The system of claim 10, wherein the at least one processor is configured to:
split, using the adaptive optimization engine, a deep learning model into a plurality of subgraphs based on the one or more model partitioning strategies, wherein the plurality of subgraphs is optimized for parallel execution across the distributed cloud nodes by at least one of balancing computational load across the the one or more distributed cloud nodes subgraphs, minimizing inter-node communication overhead during forward or backward propagation, and aligning operations of the plurality of subgraphs with hardware acceleration capabilities of the one or more distributed cloud nodes.

16. The system of claim 10, wherein the at least one processor is configured to:
deploy, using the adaptive optimization engine, the plurality of subgraphs to the one or more distributed cloud nodes based on hardware capabilities and network topology of the one or more distributed cloud nodes.

17. The system of claim 10, wherein the at least one processor is configured to:
detect, using the adaptive optimization engine, one or more failures of the one or more distributed cloud nodes; and
upon detecting the one or more failures, activate reallocation of the one or more computational tasks to the one or more distributed cloud nodes using the retrained one or more ML models.

18. The system of claim 10, wherein the at least one processor is configured to:
encrypt, using the adaptive optimization engine, one or more gradients during inter-node communication using one or more encryption techniques.

19. A non-transitory computer-readable medium storing instructions that, when executed, cause a processor to:
receive, at an adaptive optimization engine, real-time performance metrics from one or more distributed cloud nodes;
analyze, using the adaptive optimization engine, the real-time performance metrics using one or more Machine Learning (ML) models;
generate, using the adaptive optimization engine, one or more optimization policies based on the analyzed the real-time performance metrics, wherein the one or more optimization policies comprises one or more resource allocation parameters, one or more model partitioning strategies, and one or more communication protocol adjustments;
dynamically assign, using the adaptive optimization engine, one or more computational tasks to the one or more distributed cloud nodes based on the generated one or more resource allocation parameters;
upon assigning the one or more computational tasks, continuously retrain, using the adaptive optimization engine, the one or more ML models using performance feedback from the one or more distributed cloud nodes; and
update, using the adaptive optimization engine, the one or more optimization policies in the distributed cloud environments based the retrained one or more ML models.
